(19) United States
(12) Patent Application Publication
(10) Pub. No.: US 2002/0006250 A1
(43) Pub. Date: Jan. 17, 2002

(54) Multistage optical demultiplexer and multistage optical multiplexer

(75) Inventor: Berthold Wedding, Korntal-Munchingen (DE)

Correspondence Address: SUGHRUE MION ZINN MACPEAK & SEAS, PLLC, 2100 Pennsylvania Avenue, NW, Washington, DC, 20037-3213, US

(73) Assignee: ALCATEL

(21) Appl. No.: 09/871,811

(22) Filed: Jun. 4, 2001

(30) Foreign Application Priority Data
Jun. 6, 2000 (DE) 10027318.1

(51) Int. Cl. G02B 6/293

(52) U.S. Cl. 385/24; 359/127

(57) ABSTRACT

The invention relates to an optical demultiplexer with at least one input and several outputs, for distributing an optical information input to the outputs. The invention relates, in addition, to an optical multiplexer with several inputs and at least one output, for linking optical information inputs to an information output. The demultiplexer and the multiplexer are of multistage design. The individual stages are connected to one another by means of optical waveguides. In order to keep the losses within the demultiplexer/multiplexer as low as possible, it is proposed to arrange between the individual stages of the demultiplexer/multiplexer optical amplifiers (6; 16) which comprise active glass fibers or active planar waveguides doped with a metal pertaining to the rare earths and at least one energy source one energy source (being provided for several optical amplifiers

### BACKGROUND OF THE INVENTION

The invention is based on a priority application DE 100 27 318.1 which is hereby incorporated by reference.

The present invention relates to an optical demultiplexer with at least one input and several outputs. The demultiplexer serves for distributing an optical information input to several information outputs. The demultiplexer is of multistage design, the individual stages being connected to one another by means of optical waveguides. The present invention relates, in addition, to an optical multiplexer with several inputs and at least one output. The multiplexer serves for linking optical information inputs to an information output. The multiplexer is of multistage design, the individual stages being connected to one another by means of optical waveguides.

Two-stage optical demultiplexers are known from the state of the art. The demultiplexers comprise in a first stage a first splitter with at least one input and several outputs. The splitter is not wavelength-selective. But it is also possible to employ a wavelength-selective splitter. A splitter distributes an optical information input to several outputs. A non-wavelength-selective splitter divides up an input signal into several output signals which all have the same wavelength. In the case of a wavelength-selective splitter, the output signals have different wavelengths. A prism, for example, can be employed as a wavelength-selective splitter, on one side of which an input signal enters and on the other side of which several output signals with different wavelengths emerge. A splitter may also take the form of a glass-fibre-melt coupler or may be designed with planar waveguides which branch off from one or more inputs inside the coupler to several outputs. A splitter may furthermore take the form of a so-called Arrayed Waveguide Grating (AWG).

For each output of the first splitter of the first stage a further splitter with at least one input and several outputs is arranged in the second stage of the demultiplexer. The further splitters take the form of wavelength-selective splitters. If the first splitter of the first stage of the multiplexer takes the form of a 5:1 splitter and the further splitters of the second stage take the form of 8:1 splitters, an optical information input can be distributed to 40 information outputs.

Optical multiplexers of two-stage construction for linking optical information inputs to an information output are known furthermore from the state of the art. In a first stage the multiplexers comprise several first combiners with, in each case, several inputs and at least one output. The combiners of the first stage take the form of wavelength-selective combiners. In the second stage the known multiplexers comprise a further combiner with several inputs and at least one output. The outputs of the first combiners are conducted to the inputs of the further combiner. If the first combiners take the form of 8:1 combiners and the further combiner takes the form of a 5:1 combiner, with the known multiplexer the items of optical input information of 40 inputs can be linked so as to form a single information output.

The known optical demultiplexers and multiplexers can be employed in so-called Optical Add/Drop Multiplexers (OADM). Such OADMs are manufactured and marketed, for example, by Alcatel, Paris, FR, under the name Optinex 1640 OADM or by Ciena, Linthicum, US, under the name MultiWave Sentry.

The known demultiplexers and multiplexers have the disadvantage that they exhibit relatively high losses in the region of approximately 17 dB, corresponding to an attenuation by a factor of 50. Owing to the constructional features, distribution of an input signal which is available at one input to, for example, five outputs results in an attenuation of the input signal by a factor of 5. The major part of the attenuation, however, is caused by the wavelength-selective splitters or combiners. In order to prevent too great an attenuation of optical signals, in the case of the Optinex 1640 OADM manufactured by Alcatel it is known to amplify the output signal of a multiplexer and the input signal of a demultiplexer. Together with the output signal of a multiplexer and the input signal of a demultiplexer, however, not only the useful portions but, in undesirable manner, the noise portions of the signal are also amplified.

From EP 0 867 985 A1 an erbium-doped planar waveguide is known which, in conjunction with an energy source, can also be employed as an optical amplifier. An optical amplifier of such a type permits the immediate amplification of optical signals without having to make the detour via an electrical signal. The optical waveguide material that is employed for the optical amplifier is described in U.S. Pat. No. 5,491,708. It is proposed to employ the optical amplifier for the purpose of amplifying an optical signal after a certain transmission path, typically in the range from approximately 50 to 100 km. The use of the optical amplifier in certain optical components is not proposed.

### SUMMARY OF THE INVENTION

The object underlying the present invention is to configure and to develop further an optical demultiplexer and an optical multiplexer, respectively, to the effect that they exhibit an optical attenuation that is as low as possible.

With a view to achieving this object, the invention proposes, starting from the optical demultiplexer of the type specified in the introduction, that optical amplifiers which comprise active glass fibres or active planar waveguides doped with a metal pertaining to the rare earths and which comprise at least one energy source are arranged between the individual stages of the demultiplexer, one energy source being provided for several optical amplifiers.

Starting from the optical multiplexer of the type specified in the introduction, with a view to achieving the object of the present invention it is proposed that optical amplifiers which comprise active glass fibres or active planar waveguides doped with a metal pertaining to the rare earths and which comprise at least one energy source are arranged between the individual stages of the multiplexer, one energy source being provided for several optical amplifiers.

In accordance with the invention, the optical waveguides through which the individual stages of the demultiplexer or multiplexer are connected to one another accordingly take the form of optical amplifiers such as are known per se from EP 0 867 985 A1. To this end, the optical waveguides between the individual stages take the form of active glass fibres or active planar waveguides such as are known per se from U.S. Pat. No. 5,491,708. Reference is made explicitly to these two printed publications. The active glass fibres and the active planar waveguides consist of an optical waveguide material that is doped with a metal pertaining to the rare earths. The at least one energy source supplies to the optical amplifiers the necessary energy for amplifying the optical signals.

Since not every optical amplifier is provided with its own energy source, the demultiplexer/multiplexer according to the invention can be designed to be particularly small. In addition, the costs of the demultiplexers/multiplexers according to the invention can be reduced considerably, as the energy sources are relatively expensive. One energy source per demultiplexer/multiplexer is particularly advantageous for cost reasons and by reason of space-saving. With several—two for example—energy sources per demultiplexer/multiplexer the reliability can be enhanced, since the demultiplexer/multiplexer continues to operate even when one of the energy sources fails. Besides, a higher signal output power can be achieved with several energy sources.

In the case of the demultiplexer/multiplexer according to the invention the losses arising are compensated within the demultiplexer/multiplexer, that is to say where they arise. The losses of one stage of the demultiplexer/multiplexer are compensated even before the lossy optical signal reaches the next stage of the demultiplexer/multiplexer. The amplification factor of the optical amplifiers can be so chosen that the attenuation by reason of the splitters/combiners in the demultiplexer/multiplexer is partially or fully compensated or even over-compensated, i.e. the output signals have a greater power than the input signals.

For the purpose of doping the material of the glass fibres or of the waveguides, metals pertaining to the rare earths, for example ytterbium (Yb) or praseodymium (Pr) enter into consideration. According to an advantageous further development of the present invention, however, it is proposed that the material of the glass fibres or of the waveguides is doped with erbium.

According to a preferred embodiment of the present invention, it is proposed that the or each energy source takes the form of a pump laser. The pump laser supplies the necessary optical energy for amplifying the optical signals. The optical signals of the pump laser are coupled into the doped glass fibre or into the doped planar waveguide by means of a wavelength-selective optical input coupler. The wavelength of the light emitted from the pump laser is shorter than the wavelength of the optical signals conducted through the demultiplexer/multiplexer.

In advantageous manner an energy source is provided for all the optical amplifiers of the demultiplexer/multiplexer. This results in a particularly simple and small construction of the demultiplexer/multiplexer according to the invention, which furthermore can be realised in particularly cost-effective manner. The output signal of an optical amplifier with its own energy source is amplified by approximately 20 to 30 dB, i.e. by approximately a factor of 1000, in comparison with the input signal. If only one energy source is provided for five optical amplifiers, the output signal is still amplified by a factor of 200 in comparison with the input signal. This readily suffices to compensate the attenuation of the demultiplexer/multiplexer, which amounts to approximately a factor of 50.

According to a preferred embodiment of the present invention, it is proposed that the demultiplexer comprises in a first stage a first splitter with at least one input and several outputs and in all the subsequent stages for each output of a splitter of the higher-order stage a further splitter with at least one input and several outputs, the or each pump laser being linked, in each case, to a free input of a splitter.

In advantageous manner the demultiplexer comprises in a first stage a first splitter with at least one input and several outputs and in all the subsequent stages for each output of a splitter of the higher-order stage a further splitter with at least one input and several outputs, the or each pump laser being linked, in each case, to a free input of the splitter of the first stage. The optical energy of the pump laser is divided up via the first splitter to all subordinate optical amplifiers of the demultiplexer according to the invention. A splitter has several inputs as standard, only one of which is utilized conventionally when employed in a demultiplexer. The pump laser is linked to one of the remaining free inputs of the splitter. Further pump lasers can be linked to the remaining free inputs, e.g. in order to enhance the reliability and the signal output power of the demultiplexer.

The first splitter of the first stage preferably takes the form of a non-wavelength-selective splitter. Alternatively, it is proposed that the splitter of the first stage takes the form of a wavelength-selective splitter, the wavelength of the light of the pump laser lying outside the selection range of the splitter. A typical selection range of a splitter lies in the range between 1550 nm and 1580 nm. The wavelength of the light of the pump laser then amounts, for example, to 980 nm or 1480 nm. By this means it is ensured that the light of the pump laser is uniformly distributed to all the outputs of the splitter and hence to all the optical amplifiers.

According to a preferred embodiment of the present invention, it is proposed that the multiplexer comprises in a first stage several first combiners with, in each case, several inputs and at least one output and in all the subsequent stages at least one further combiner with, in each case, one input for each output of the first combiners of the higher-order stage and at least one output, the or each pump laser being linked, in each case, to a free output of a further combiner. Further pump lasers can be linked to the remaining free outputs, e.g. in order to enhance the reliability and the signal output power of the multiplexer.

In advantageous manner the multiplexer comprises in a first stage several first combiners with, in each case, several inputs and at least one output and in all the subsequent stages at least one further combiner with, in each case, one input for each output of the first combiners of the higher-order stage and at least one output, the or each pump laser being linked, in each case, to a free output of the further combiners of the final stage.

Via the free output of the further combiner of the final stage the optical energy of the pump laser is distributed to optical amplifiers placed upstream of the further combiner.

The further combiner of the final stage preferably takes the form of a non-wavelength-selective combiner. Alternatively, it is proposed that the further combiner of the final stage takes the form of a wavelength-selective combiner, the wavelength of the light of the pump laser lying outside the selection range of the further combiner.

### DESCRIPTION OF THE DRAWINGS

Further features, possible applications and advantages of the invention will become apparent from the following description of examples of embodiments of the invention which are represented in the drawing. In this connection, all the features described or represented, on their own or in any combination, constitute the subject-matter of the invention, irrespective of their synopsis in the claims or the subordinating references therein and also irrespective of their formulation and representation, respectively, in the description and in the drawing. Illustrated are:

FIG. 1 an optical demultiplexer according to the invention according to a preferred embodiment,

FIG. 2 an optical multiplexer according to the invention according to a preferred embodiment, and

FIG. 3 an optical amplifier known from the state of the art.

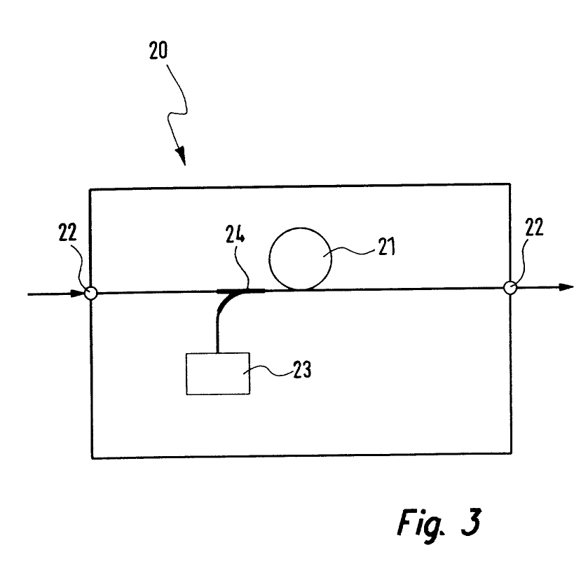

In FIG. 3 an optical amplifier such as is known per se, for example from EP 0 867 985 A1, is denoted in its entirety by reference symbol 20. The optical amplifier 20 comprises an erbium-doped glass fibre or an erbium-doped planar waveguide 21, such as are known per se from U.S. Pat. No. 5,491,708. Reference is made explicitly to these two printed publications.

At the input and at the output of the optical amplifier 20 there is arranged, in each case, an insulator 22 which—like diodes in the case of electrical signals—permits the optical signals to pass through in only one direction. Without insulators 22, reflections in the course of the coupling and decoupling of the optical signal to be amplified would result in a build-up of the signal within the optical amplifier 20.

The optical amplifier 20 comprises, in addition, a pump laser 23, the light of which is coupled into the erbium-doped fibre 21 in wavelength-selective manner via an optical input coupler 24. The wavelength of the light of the pump laser 23 is shorter than the wavelength of the signal to be amplified. The signal to be amplified has, for example, a wavelength of 1550 nm, whereas the light of the pump laser 23 has, for example, a wavelength of 980 nm or 1480 nm. With the optical amplifier which is represented in FIG. 3 an optical signal is amplified by 20 to 30 dB, that is to say approximately by a factor of 1000. The mode of operation of such an optical amplifier is described in detail in EP 0 867 985 A1.

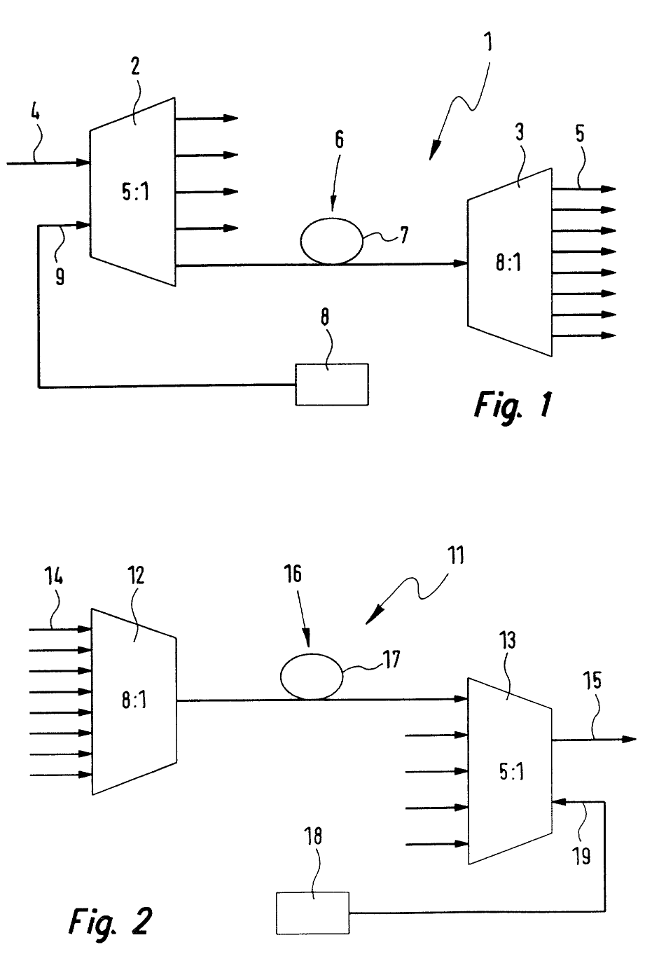

In FIG. 1 an optical demultiplexer according to the present invention is denoted in its entirety by reference symbol 1. The demultiplexer 1 is of two-stage construction, a first stage comprising a first splitter 2 and a second stage comprising five further splitters 3, only one of which is represented in FIG. 1. With the aid of the demultiplexer 1, an item of optical input information which is available at an input 4 of the first splitter 2 can be distributed to several outputs 5 of the further splitters 3. With the demultiplexer 1 which is represented in FIG. 1 the information input can be distributed to 40 outputs 5. The first splitter 2 takes the form of a non-wavelength-selective 5:1 splitter. The further splitters 3 take the form of wave-selective 8:1 splitters.

Between the first splitter 2 of the first stage and the further splitters 3 of the second stage there are arranged optical amplifiers 6, only one of which is represented in exemplary manner in FIG. 1. The optical amplifiers 6 include a glass fibre 7 doped with a metal pertaining to the rare earths and also an energy source 8. The glass fibre 7 is doped with erbium. Alternatively, it may also be doped with ytterbium (Yb) or praseodymium (Pr). Instead of a glass fibre 7, a planar waveguide doped with a metal pertaining to the rare earths may also be employed. The energy source 8 takes the form of a pump laser.

In order that not every doped glass fibre 7 has its own energy source 8 assigned to it, in accordance with the invention it is proposed to link the energy source 8 to a free input 9 of the first splitter 2 of the first stage. Via the first splitter 2 the optical energy of the pump laser is distributed to all optical amplifiers 6 linked to the outputs of the first splitter 2. In this way, although each optical amplifier 6 receives only a fifth of the total energy of the pump laser, this energy suffices without difficulty in order to compensate the losses arising within the demultiplexer 1. The attenuation of the demultiplexer 1 is approximately in the region of 17 dB, whereas with the demultiplexer 1 according to the invention which is represented in FIG. 1 an amplification of the optical signals with the individual optical amplifiers 6 by, in each case, approximately 23 dB is possible.

In the case of the demultiplexer 1 according to the invention, in comparison with the optical amplifiers 20 known from the state of the art only one pump laser is provided for all erbium-doped glass fibres. Furthermore, the optical input coupler 24 and the insulators 22 can be dispensed with. As a result, the demultiplexer 1 according to the invention can be designed to be particularly small and cost-effective.

In FIG. 2 an optical multiplexer according to the invention is denoted in its entirety by reference symbol 11. The multiplexer 11 is of multistage design, comprising in a first stage five first combiners 12 and in a subsequent second stage a further combiner 13. The multiplexer 11 serves for linking items of optical input information which are available at the inputs 14 of the first combiner 12 so as to form a common item of output information which is available at an output 15 of the further combiner 13.

Between the first combiners 12 of the first stage and the further combiner 13 of the second stage of the multiplexer 11 there are arranged, in each case, optical amplifiers 16. The optical amplifiers 16 each include a glass fibre 17 doped with a metal pertaining to the rare earths. The glass fibre 17 is doped with erbium; but it may likewise also be doped with ytterbium (Yb) or praseodymium (Pr). Instead of the doped glass fibre 17, a doped planar waveguide may also be employed. A common energy source 18 which takes the form of a pump laser is assigned to all the doped glass fibres 17. The energy source 18 is linked to a free output 19 of the further combiner 13 of the second stage. The optical energy of the pump laser is uniformly distributed via the further combiner 13 to all optical amplifiers 16 connected in series upstream.

The first splitter 2 of the first stage of the demultiplexer 1 takes the form of a non-wavelength-selective splitter. But it would also be conceivable to design the first splitter 2 as a wavelength-selective splitter, so long as the wavelength of the light of the energy source 8 lies outside the selection range of the splitter 2. Similarly, the further combiner 13 of the second stage of the multiplexer 11 takes the form of a non-wavelength-selective combiner. It could likewise take the form of a wavelength-selective combiner, provided that the wavelength of the light of the energy source 18 lies outside the selection range of the further combiner 13.

1. An optical demultiplexer with at least one input and several outputs, for distributing an optical information input to several information outputs, the demultiplexer being of multistage design and the individual stages being connected to one another by means of optical waveguides, optical amplifiers comprising active glass fibres or active planar waveguides doped with a metal pertaining to the rare earths and comprising at least one energy source are arranged between the individual stages of the demultiplexer, one energy source being provided for several optical amplifiers

2. An optical multiplexer with several inputs and at least one output, for linking optical information inputs to an information output, the multiplexer being of multistage design and the individual stages being connected to one another by means of optical waveguides, optical amplifiers comprising active glass fibres or active planar waveguides doped with a metal pertaining to the rare earths and compriseing at least one energy source are arranged between the individual stages of the multiplexer, one energy source being provided for several optical amplifiers

3. Demultiplexer according to claim 1 or multiplexer according to claim 2, the material of the glass fibres or of the waveguides is doped with erbium.

4. Demultiplexer or multiplexer according to one of claims 1 to 3, where at least one energy source takes the form of a pump laser.

5. Demultiplexer or multiplexer according to one of claims 1 to 4, an energy source is provided for the optical amplifiers.

6. Demultiplexer according to claim 4, demultiplexer comprising in a first stage a first splitter with at least one input and several outputs and in all the subsequent stages for the output of a splitter of the higher-order stage a further splitter with at least one input and several outputs, the pump laser being linked to a free input of a splitter.

7. Demultiplexer according to claims 4 and 5, demultiplexer comprising in a first stage a first splitter with at least one input and several outputs and in all the subsequent stages for the output of a splitter of the higher-order stage a further splitter with at least one input and several outputs, the pump laser being linked to a free input of the first splitter of the first stage.

8. Demultiplexer according to claim 7, where the first splitter of the first stage takes the form of a non-wavelength-selective splitter.

9. Demultiplexer according to claim 7, the first splitter of the first stage takes the form of a wavelength-selective splitter, the wavelength of the light of the pump laser lying outside the selection range of the first splitter.

10. Multiplexer according to claim 4, the multiplexer comprising in a first stage several first combiners with several inputs and at least one output and in all the subsequent stages at least one further combiner with an input for the output of the first combiners of the higher-order stage and at least one output, the pump laser being linked to a free output of a further combiner.

11. Multiplexer according to claims 4 and 5, the multiplexer comprising in a first stage several first combiners with several inputs and at least one output and in all the subsequent stages at least one further combiner with an input for the output of the first combiners of the higher-order stage and at least one output, the pump laser being linked to a free output of the further combiner of the final stage.

12. Multiplexer according to claim 11, the further combiner of the final stage takes the form of a non-wavelength-selective combiner.

13. Multiplexer according to claim 11, the further combiner of the final stage takes the form of a wavelength-selective combiner, the wavelength of the light of the pump laser lying outside the selection range of the further combiner.
